(19) United States
(12) Patent Application Publication
(10) Pub. No.: US 2011/0014058 A1
(43) Pub. Date: Jan. 20, 2011

(54) PROPELLER

(75) Inventor: Carsten CLEMEN, Mittenwalde (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/835,356

(22) Filed: Jul. 13, 2010

(30) Foreign Application Priority Data
Jul. 14, 2009 (DE) 10 2009 032 719.3

(51) Int. Cl. B64C 27/467

(52) U.S. Cl. 416/223 R

(57) ABSTRACT

On a propeller, more particularly one for aircraft applications, an efflux slot (6) originating at the propeller blade trailing edge (5) is provided in the transition area between propeller blade (3) and hub (2) for improving the secondary airflow and dimensioned such that precisely the air boundary layer, but not the main flow, is allowed to flow off. Propeller losses are reduced and propeller thrust and efficiency are increased.

This invention relates to a propeller, more particularly one for aircraft applications, including a propeller hub attached to a drive shaft and disposed with propeller blades.

Propellers are non-enclosed fluid flow machines with airfoils or blades disposed on a hub and flown by the ambient medium by reason of the rotation of a hub connected to a drive shaft. The propeller blades can be integrally connected to the hub or—as separately manufactured components—threadedly or weldedly connected to the hub, Furthermore, the propeller blades can also be rotatably borne about their vertical axis in the propeller hub. The known propellers are disadvantageous in that secondary flow phenomena, such as turbulence and edge separation, occur in the transition area between the propeller hub and the propeller blade, entailing performance losses and ultimately leading to a reduction of efficiency and thrust.

In a broad aspect, the present invention provides for the development of a propeller, more particularly one for aircraft applications, such that propeller performance, propeller efficiency and thrust are improved.

It is a particular object of the present invention to provide solution to the above problematics by a propeller designed in accordance with the features of patent Claim 1. Advantageous developments of the present invention become apparent from the sub-claims.

The present invention, in its essence, provides for an efflux slot originating at the trailing edge of each propeller and longitudinally adjoining the propeller hub, with said efflux slot being dimensioned such that precisely the air boundary layer, but not the main flow, is allowed to flow off. Thus, by avoiding edge separation and turbulences, the secondary airflow is improvable in the transition area between propeller blades and propeller hub, as a result of which propeller losses are reduced and propeller efficiency correspondingly increased.

in development of the present invention, the height of the efflux slot is at most 0.5% of the propeller blade height measured between the propeller blade tip and the hub axis. A slot height near 0.1% of the propeller blade height has proved to be particularly advantageous. The length of the efflux slot lies between 10 and 50% of the chord length of the propeller blade measured at the propeller hub.

In a further development of the present invention, the height of the efflux slot is constant. This means that the efflux slot extends at a constant distance along the contour of the propeller hub. However, the height of the efflux slot can also gradually decrease towards the leading edge.

The efflux slot can be provided in both, propeller blades rigidly connected to the propeller hub and propeller blades attached to a rotary disk located in the propeller hub.

The present invention is more fully described in light of the accompanying drawing showing a preferred embodiment. In the drawing,

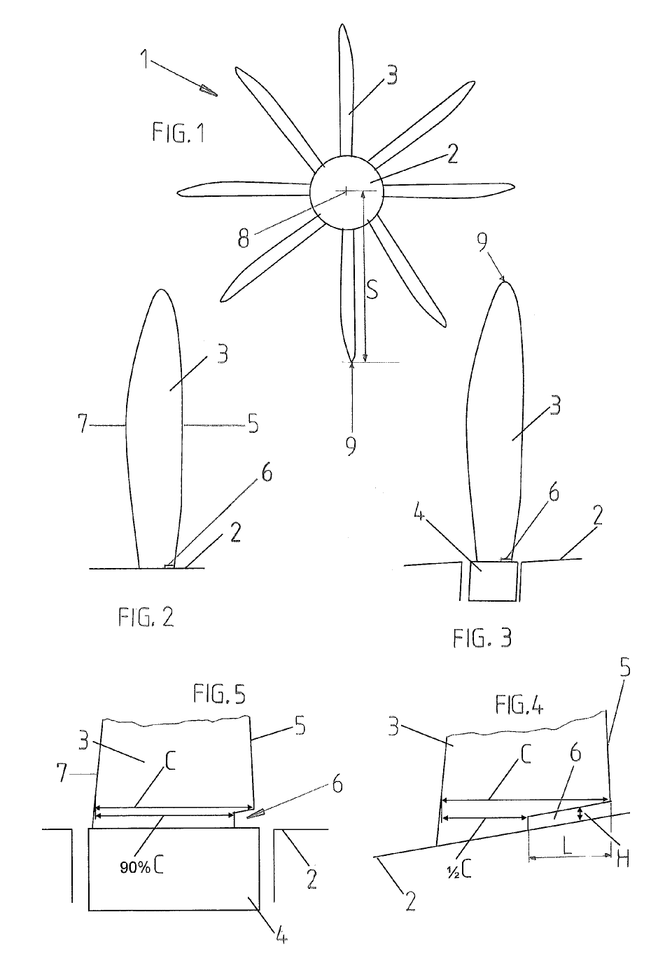

FIG. 1 shows a front view of a propeller,

FIG. 2 shows a propeller blade rigidly connected to the propeller hub,

FIG. 3 shows a propeller blade that is swivellable in the propeller hub,

FIG. 4 is an enlarged schematic representation of the transition area between propeller blade and propeller hub, and

FIG. 5 is an enlarged schematic representation of the transition area between a rotary disk borne in the hub and the propeller blade attached to the rotary disk.

FIG. 1 shows a propeller 1 with propeller blades 3 which, extending from a propeller hub 2, can be rigidly connected to the propeller hub 2—as shown in FIG. 2—or attached to a rotary disk 4 being rotatably borne in the propeller hub 2—as shown in FIG. 3—and thus swivellable about their longitudinal axis. Due to the high rotational speed and the extremely thick profile of the propeller blades used in the state of the art, flow separations and turbulences occur in the transition area between propeller blade and propeller hub resulting in propeller losses. This secondary flow phenomenon, and the losses resulting therefrom, is counteracted by an efflux slot 6 which is formed into the propeller blade trailing edge 5 and immediately adjoins the surface of the propeller hub 2. Height H of the efflux slot 6 is selected such that precisely the air boundary layer, but not the main airflow, is allowed to flow off. The length of the efflux slot 6 is—as shown in FIG. 5—at least 10% of the chord length C of the propeller blade 3 at the propeller hub 2 and—as shown in FIG. 4—at most 50% of the chord length C. The shape of the efflux slot 6 preferably follows the hub contour (FIG. 4), but may narrow in the direction of the leading edge 7 of the propeller blade 3—as shown in FIG. 5. The height H of the efflux slot 6 is at most 0.5% of the propeller blade height S reaching from the hub axis 8 to the propeller blade tip 9. An optimum value of the height H of the efflux slot 6 is at 0.1% of the propeller blade height S. This design of the propeller geometry in the transition area between the propeller hub and the propeller bade, and the thereby improved secondary flow in this area, reduces propeller losses and increases propeller thrust. With the propeller thrust being increasable by 0.5%, fuel consumption is decreased.

### LIST OF REFERENCE NUMERALS

1 Propeller
2 Propeller hub
3 Propeller blade
4 Rotary disk
5 Propeller blade trailing edge
6 Efflux slot
7 Leading edge
8 Hub axis
9 Propeller blade tip
H Height of 6
L Length of 6
S Propeller blade height

1. Propeller, more particularly one for aircraft applications, including a propeller hub (2) attached to a drive shaft and disposed with propeller blades (3) featuring a leading edge (7), a propeller blade trailing edge (5) and a propeller blade tip (9), characterized by an efflux slot (6) provided in the transition area between propeller blade and hub for improving the secondary airflow and originating at the propeller blade trailing edge (5), with said efflux slot being dimensioned such that precisely the air boundary layer is allowed to flow off.

2. Propeller in accordance with claim 1, characterized in that the height (H) of the efflux slot (6) is at most 0.5% of the propeller blade height (S) measured between the propeller blade tip (9) and the hub axis (8).

3. Propeller in accordance with claim 2, characterized in that the height (H) of the efflux slot (6) is 0.1% of the propeller blade height (S).

4. Propeller in accordance with claim 1, characterized in that the length (L) of the efflux slot (6) lies between 10 and 50% of the chord length (C) of the propeller blade at the propeller hub.

5. Propeller in accordance with claim 2, characterized in that the height (H) of the efflux slot (6) follows the contour of the propeller hub (2) and is constant.

6. Propeller in accordance with claim 2, characterized in that the height (H) of the efflux slot (6) gradually decreases towards the leading edge (7).

7. Propeller in accordance with claim 1, characterized in that the propeller blades (3) are attached directly to the propeller hub (2) or to a rotary disk (4) located in the propeller hub (2).
